(19) United States
(12) Patent Application Publication
(10) Pub. No.: US 2021/0250519 A1
(43) Pub. Date: Aug. 12, 2021

(54) SIMULTANEOUS INSPECTION OF MULTIPLE SURFACES OF AN OBJECT

(71) Applicant: Sudeep Sundaram, Bangalore, Karnataka (IN)

(72) Inventors: Sudeep Sundaram, Bangalore, Karnataka (IN); Anupriya Balikai, Bangalore, Karnataka (IN)

(21) Appl. No.: 16/972,833

(22) PCT Filed: Jan. 23, 2019
(86) PCT No.: PCT/IN2019/050051

§ 371 Date: Dec. 7, 2020

(30) Foreign Application Priority Data
Jun. 9, 2018 (IN) 201841021647

(51) Int. Cl. H04N 5/247; G06T 7/00; H04N 7/18

(52) U.S. Cl. CPC H04N 5/247; H04N 7/181; G06T 7/001

(57) ABSTRACT

The present invention discloses a system and method for scanning two sides of an object simultaneously for detecting defects in the object. In the disclosed method, objects are placed on a conveyor belt (102) which is capable of transporting objects through the system. The system comprises a duality of line image scanners (106a-b) for scanning two sides of the object on the conveyor belt (102), i.e. the front and back, through a slit (105) present in the conveyor belt (102). The scanned images are further processed to detect defects in the objects, and defective objects are stored separately to avoid further use. The defective and non-defective objects are sent to two separate receptacles disposed in the disclosed system.

### TECHNICAL FIELD

The invention relates to the field of defect detection in conveyor systems. More specifically, it relates to the field of automatic scanning of objects and processing generated images to detect defects in the objects.

### BACKGROUND ART

Various methods of finding defects in objects have been implemented over the years, of which scanning objects through an image scanner has been the most reliable method of defect detection in objects.

Conventional systems and methods for detecting defects in objects disclose methods of scanning only one surface of the object at a time or multiple surfaces in multiple stages. The cost of implementation of the existing methods is high, and the whole process also becomes time-consuming since the surfaces are scanned one after the other. Additionally, the existing scanning and inspection systems inspect multiple sides of a product in multiple stages. Therefore, these systems are bulky, require significant space and have numerous components. This makes the installation and maintenance of such systems a herculean task. Additionally, conventional systems fail to provide a system where “relative” patterns, textures or their orientations on the two sides need to be verified.

The conventional scanning systems and methods fail to achieve successful scans on multiple sides of an object that passes on a conveyor belt. As conventional systems scan one side of the object at a time, the scanning process becomes time consuming while scanning multiple sides in a row. Also, when an object is not positioned properly on the conveyor belt, there are high possibilities that the scanning may not occur or may occur incorrectly for a misplaced object.

Another drawback in the existing methods is that, every time an object with new dimensions, unknown to the scanning mechanism, is introduced in the system, the dimensions need to be either manually fed or detected in the system. Also, in the conventional system, though a defective object is identified by scanning single side of said object at a time, a mechanism for sending out defective objects and non-detective objects separately through different outlets is un-available.

There is, therefore, a long felt need for a scanning mechanism that is less time consuming and easier to implement, and one that requires less human intervention. Hence, there is an utmost need for a scanning system and method that can overcome the above-mentioned problems.

### SUMMARY OF INVENTION

The present invention discloses a system and method for inspecting defects on multiple surfaces of an object at the same time, and identifying a defective object using line image scanners. The object is carried by a conveyor belt through the system. Two line-image scanners are employed for scanning pixels of the object. In order to scan the pixels, movement of the line image scanner or the object is made perpendicular to the line of pixels. The conveyor belt comprises a slit and the width of the slit is decided based on one or more objects and conveyance parameters. The object is scanned and multiple images of both surfaces of the object are developed. Multiple images corresponding to a single side of the object are combined together to generate entire image of the side of the object.

The images are generated and subsequently sent to an image processor to identify defects in the object. The defects are identified based on a comparison between the generated image and a pre-existing image of a non-defective object in the system. Simultaneously, when a set of non-defective objects are carried by the conveyor belt into the system, the system automatically learns and determines specifications of a standard image. A machine learning module disposed in a control panel measures dimensions of new objects that are not calculated in previous scans and calibrates the line image scanners with respect to the new dimensions, thereby reducing any delay when the line image scanners are switched between different objects. The conveyor belt comprises two output receptacles. One receptacle is used to store a set of objects with no defects for further use and another receptacle is set to store a set of objects with defects to avoid further use.

### BRIEF DESCRIPTION OF DRAWINGS

This invention is illustrated in the accompanying drawings, throughout which, like reference letters indicate corresponding parts in the various figures.

The embodiments herein will be better understood from the following description with reference to the drawings, in which:

FIG. 1

FIG. 1 illustrates a scanning system used for scanning surfaces of objects.

FIG. 2A

FIG. 2(A) illustrates a cross-view of a dual image scanner setup.

FIG. 2B

FIG. 2(B) illustrates a side view of a dual image scanner setup.

FIG. 2C

FIG. 2(C) illustrates a sectional view of a dual image scanner setup.

FIG. 3

FIG. 3 illustrates an exemplary scanned image of two sides of a coin and various parameters of the coin that are scanned by an imaging setup.

FIG. 4

FIG. 4 represents a flowchart elaborating a method of functioning of an object scanning system.

### DESCRIPTION OF EMBODIMENTS

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein provide a system and a method for scanning front and back surfaces of an object simultaneously while the object is transported on a conveyor belt.

In the scope of the present invention, a line image scanner is an imaging camera that scans an object in pixels. To achieve this, the movement of either the camera or the objects to be scanned requires to be perpendicular to the line of pixels.

In the context of the present invention, the conveyor belt may be a sliding metal plate and the like.

The invention discloses a system and a method for simultaneous scanning of front and back surfaces of objects while they move on a conveyor belt. Two line-image scanners are setup above and below the object conveyor belt respectively for this purpose. The conveyor belt mechanism comprises a slit right in front of the line image scanners, where the width of the slit is decided based on the object and conveyance parameters, after which an image scanner setup with an appropriate resolution is chosen. The images generated by these scanners are sent to image processors disposed in said system to detect presence of any defects in the objects. Multiple images captured by these line image scanners/cameras are stitched together in a server or a backend system to build an entire image of each side of the product being inspected. In case a defect is detected in an object, the object can be transported to a receptacle and can be removed thereafter.

In the context of the present invention, a scanning system may be a system furnished with an image scanner setup that is used for simultaneously scanning multiple surfaces of an object passing under it.

Referring now to the drawings, where similar reference characters denote corresponding features consistently throughout the figures, there are shown preferred embodiments.

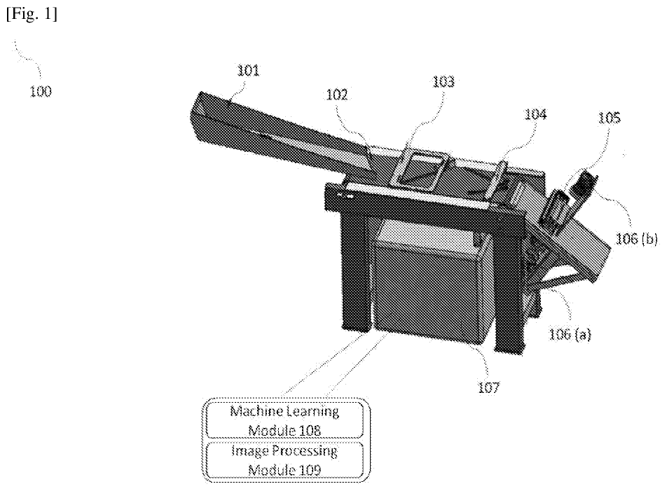

FIG. 1 illustrates a scanning system 100 comprises a linear vibrator feeder 101 for receiving one or more objects and an object conveyor 102 on which the objects are transported.

Once the objects are received through the linear vibrator feeder 101, they fall onto an object conveyor 102. The object conveyor 102 is a mechanical conveyor belt that constantly moves forward when the scanning system 100 is supplied with power. An object separator 103 is present in the scanning system 100 over the object conveyor 102. The main function of the object separator 103 is to separate the multiple objects in case an object is placed on top of another object, since such a condition may not be favorable for scanning the surfaces of the objects.

Further, an object aligner 104 aligns the objects on the object conveyor 102 for consistent and accurate scanning of the surfaces of the objects. The scanning system 100 further comprises a slit 105 for the line scanning of the surfaces of the objects. The scanning system 100 further comprises a dual line image scanner/line image camera setup 106 to generate images of surfaces of one or more objects on an object conveyor 102.

The duality of line image scanners 106(a)-(b) are line image scanners employed to scan the surfaces of the objects on the object conveyor 102. A person skilled in the art will realize that line image scanner 106(a) and line image scanner 106(b) scan single lines of pixels of objects in front of the image scanners, and these scanners are widely used in places where the objects are continuously moving.

Multiple line images are sent to a server or to the scanning system 100 where they are stitched together to generate a complete image, termed as a generated image, of both sides of the product. Complete images of both the surfaces of the object are developed and further sent to an image processing module 109 disposed in a control panel 107 or in the server or the scanning system 100.

The image processing module 109 utilizes the generated images of the surfaces of the objects and detects one or more defects in the objects. The various defects detected by the image processing module 109 are constituted in, but not limited to, surface misalignment, stains on the surface, dents on the objects, color defects and defects on the surfaces of the objects. The defects are determined based on a comparison of the generated image with a pre-existing image of a non-defective object. In an alternate embodiment, the system 100 may automatically learn and determine a standard image, to be used for later comparison, when a set of non-defective products are transported on the object conveyor 102.

In an embodiment, the scanning system 100 is powered by an external power source.

Any person skilled in the art will realize that the power source can be anything such as, but not limited to, a standard electric voltage supply, solar energy, and inverter systems.

In one embodiment, the control panel 107 may also be configured to allow a user to control the scanning system 100.

In the preferred embodiment, a machine learning module 108 is also disposed in the control panel 107. In a case a novel object, whose dimensions are not already calibrated in the scanning system 100, is introduced in said system, the machine learning module 108 measures the dimensions of the novel object and calibrates the line image scanner 106(a) and the line image scanner 106(b) according to newly measured dimensions of the novel object. The machine learning module 108 also allows said line image scanners 106(a)-(b) to switch between variants of objects without any delays or hassle.

The object conveyor 102 is further extended to transport objects to two output receptacles (not shown in the figure). In an embodiment, a set of objects in which no defects have been detected are sent to one of the receptacles for further utilization, and a set of objects in which defects have been detected are sent to another receptacle to avoid further use of the defective objects.

In one embodiment, the scanning system 100 may be externally connected to user devices. A person skilled in the art will realize that a user device can be anything such as, but not limited to, a mobile phone, a computer, a laptop or any other mobile device; and may be connected in a wired or a wireless connection. The wired communication can be carried out by any network configuration such as LAN, WAN, etc. and the wireless communication can be done through Mobile Service Provider (MSP) and Internet Service Provider (ISP) having internet connection provided by an ISP provider, 2G/3G/4G/5G internet connection provided by the mobile service provider etc. Such wired or wireless communication is not possible without the standard protocols as known in the art, where the standard protocols can be TCP/IP, HTTP, FTP, UDP, IPV4, IPV6 etc.

In one embodiment, a real time analysis of the scanning system 100 may be communicated with the user device, for the user to remotely monitor the scanning system 100 and the scanning process.

In one exemplary embodiment, the scanning system 100 may be implemented for scanning defects in coins that have been newly minted. Coins which are newly printed from a mint are provided to the scanning system 100 in order to scan both surfaces of the coin. The scanning system can detect defects in the coin surfaces or the colors, and segregate defective coins from non-defective coins into different receptacles. Hence, the defective coins can be removed and will not be used further.

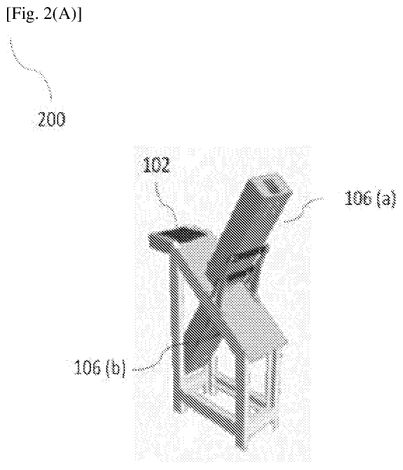

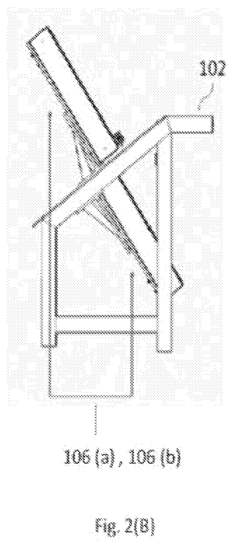

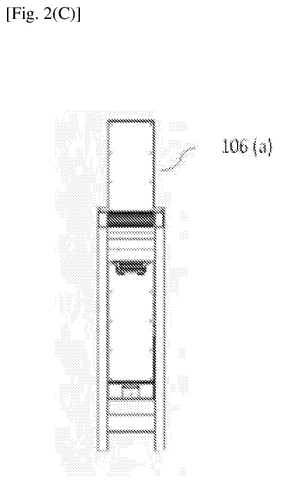

FIG. 2(a) depicts a cross view of a duality of a line image scanner 106(a) and a line image scanner 106(b). FIG. 2(b) depicts the side view of the duality of the line image scanner 106(a) and the line image scanner 106(b). The said line image scanner 106(a) and the line image scanner 106(b) are set up in a way that the line image scanner 106(a) and the line image scanner 106(b) are exactly opposite to each other and perpendicular to the object conveyor 102. FIG. 2(c) depicts the sectional view of the duality of the line image scanner 106(a) and the line image scanner 106(b).

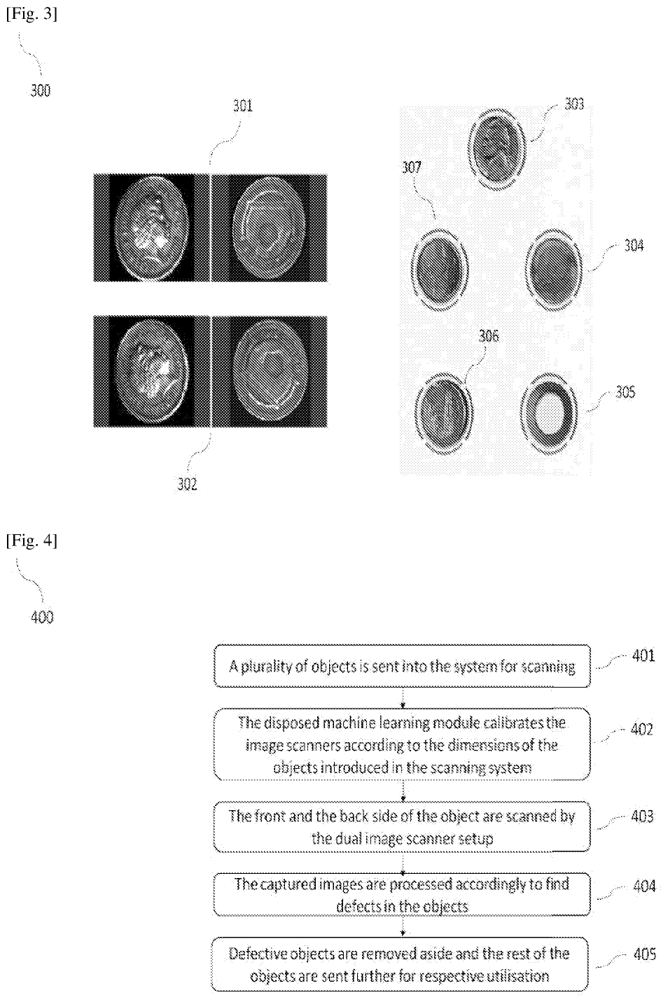

FIG. 3 illustrates an exemplary representation of the scanned images of the surfaces of the coins. The front and the back surfaces of the coins require to be aligned properly as depicted by illustration 301. The scanning system (not shown in the figure) detects misalignment in the surfaces of the coins as depicted by illustration 302. Illustration 303 depicts minting defects in the coins, 304 depicts stain defects on the surfaces of the coins, and 305 depicts the eccentricity defects in the minted coins. Rim defects and dents in the coins that are detected by the scanning system 100 are depicted in the illustration 306, and the illustration 307 depicts dents on the surfaces of the minted coins.

FIG. 4 illustrates a flowchart of a working process of the scanning system. A plurality of objects is first introduced into the scanning system 100 from the vibratory tray as depicted at step 401. The machine learning module 108 disposed in the scanning system 100 calibrates the line image scanner 106(a) and line image scanner 106(b) according to the different dimensions of the objects introduced in the scanning system 100, as depicted at 402. When the objects pass through the line image scanners 106(a) and 106 (b), front and back sides of the objects are scanned simultaneously by the dual image scanner setup, as depicted at step 403. Further, at step 405, the images of the object are captured and sent for the purpose of image processing which helps in detecting the defects in the objects. If defects are detected in the objects, the respective objects are removed from the scanning system 100, while the rest of the objects are sent for further utilization, as depicted at step 406.

The system disclosed in the disclosure has several benefits over existing arts. The system is constructed in a way that it has a minimal retrofit design that reduces the human intervention required in the maintenance of the system. The disclosed scanning system is also capable of achieving high speed in scanning the objects with ease, and also has a pneumatic system in place to remove the defective objects from the system.

The foregoing description of the specific embodiments will so fully general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described here.

1. A system (100) for simultaneous inspection of multiple surfaces of an object, the system (100) comprising:
a line vibrator feeder (101) for receiving the object to be scanned;
an object conveyor (102) for transporting said object;
an object separator (103) for separating the object from another object on the object conveyor (102);
an object aligner (104) for aligning the object on the object conveyor (102);
two line-image scanners (106) for simultaneously scanning front and back surfaces of the object; and
an image processing module (109) for detecting defective objects from scanned images.

2. The system as claimed in claim 1, wherein the line image scanners (106) scan single line of pixels of the continuously moving objects, and wherein the generated image is sent to the image processing module (109) to identify defective objects.

3. The system as claimed in claim 2, wherein multiple images of both sides of the object are sent to a server or a backend system and the multiple images are combined together to generate a complete image of both sides of the object, and wherein the identification is performed by comparing the generated image with a pre-existing image of a nondefective object in the system.

4. The system as claimed in claim 1, wherein the conveyor (102) comprises a sliding metal plate with a slit (105) in front of the line image scanners (106), wherein the system comprises a machine learning module (108) for measuring unknown dimensions of a new object, and wherein the machine learning module (108) calibrates the line image scanners (106) with the measured dimension of new objects and allows the line image scanners (106) to switch between different objects without delay.

5. The system as claimed in claim 1, wherein the conveyor (102) comprises two output receptacles in which a set of objects without defects are sent through one receptacle for further use and a set of objects with defects are sent through the other receptacle to avoid further use. detect defective objects, said method comprising:
sending a plurality of objects to a scanning system (100);
calibrating two line image scanners (106) according to the dimension of objects sent to the scanning system;
scanning multiple sides of the objects by the two line image scanners (106) of the scanning system;
generating multiple images of both sides of the object and combining the multiple images together to generate a complete image of both sides of the object;
sending the generated images to an image processing module (109) to identify defective objects; and
removing defective objects and sending non-defective objects for further utilization.

7. The system as claimed in claim 6, wherein the line image scanners (106) scan single line of pixels of the continuously moving objects, and wherein the generated image is sent to the image processing module (109) to identify defective objects.

8. The system as claimed in claim 6, wherein multiple images of both sides of the objects are sent to a server or a backend system, wherein the multiple images are combined together to generate a complete image of both sides of the objects, and wherein the identification is performed by comparing the generated image with a pre-existing image of a non-defective object in the system.

9. The system as claimed in claim 6, wherein the conveyor (102) comprises a sliding metal plate with a slit (105) in front of the line image scanners (106), wherein the system comprises a machine learning module (108) for measuring unknown dimensions of a new object, and wherein the machine learning module 108 calibrates the line image scanners (106) with the measured dimension of new objects and allows the line image scanners (106) to switch between different objects without delay.

10. The system as claimed in claim 6, wherein the conveyor (102) comprises two output receptacles in which a set of objects without defects are sent through one receptacle for further use and a set of objects with defects are sent through the other receptacle to avoid further use.
